(19) United States
(12) Patent Application Publication
(10) Pub. No.: US 2003/0104965 A1
(43) Pub. Date: Jun. 5, 2003

(54) Laundry sanitizer containing partially halogenated hydantoins

(75) Inventors: Michael Fred Czuczak, Dayton, NJ (US); Andrew James Kaziska, Whitehouse Station, NJ (US)

Correspondence Address: DARBY & DARBY P.C., P. O. BOX 5257, NEW YORK, NY, 10150-5257, US

(73) Assignee: Lonza Inc.

(21) Appl. No.: 10/218,889

(22) Filed: Aug. 13, 2002

Related U.S. Application Data
(60) Provisional application No. 60/312,504, filed on Aug. 14, 2001.

(51) Int. Cl. C11D 1/00; D06M 10/00

(52) U.S. Cl. 510/384; 510/461; 8/115.51

(57) ABSTRACT

The present inventors have discovered that partially halogenated hydantoins, such as monochlorodimethyl hydantoin, effectively sanitize textiles with minimal color fading and textile degradation. The present invention is a method of sanitizing a textile by applying a sanitizing effective amount of a partially halogenated hydantoin to the textile. Preferably, a sanitizing, color safe, and textile safe effective amount of partially halogenated hydantoin is applied to the textile. The present invention is also directed to a method of cleaning and sanitizing a textile by applying a detergent and a sanitizing effective amount of partially halogenated hydantoin to the textile. The present invention is further directed to a sanitizing and detergent composition which includes a detergent and a sanitizing effective amount of at least one partially halogenated hydantoin.

This application claims the benefit under 35 U.S.C. §119(e) of U.S. Provisional Application No. 60/312,504, filed Aug. 14, 2001, which is hereby incorporated by reference.

### FIELD OF THE INVENTION

The present invention relates to laundry sanitizing compositions containing partially halogenated hydantoins and a method of sanitizing textiles with the same.

### BACKGROUND OF THE INVENTION

Sanitizers, such as hypochlorites, sodium dichloroisocyanurate (DCCA), sodium perborate, and sodium nonanoyl oxybenzene sulfate (SNOBS), are often included in or added to laundry detergent formulations. However, many current sanitizers, such as liquid hypochlorite bleaches and sodium DCCA, are not color safe or fabric safe, i.e., they change the color or damage the fabric to which they are applied.

There is a continuing need for improved sanitizers which do not fade colors or damage fabrics.

### SUMMARY OF THE INVENTION

The present inventors have discovered that partially halogenated hydantoins, such as monochlorodimethyl hydantoin (MCDMH), are surprisingly effective as sanitizing agents for textiles, and result in minimal color fading and textile degradation. The present invention is a method of sanitizing a textile (such as a colored textile) by applying a sanitizing effective amount of a partially halogenated hydantoin to the textile. Preferably, a sanitizing, color safe, and textile safe effective amount of partially halogenated hydantoin is applied to the textile.

Another embodiment is a textile sanitizing composition which comprises a partially halogenated hydantoin and, optionally, one or more additives such as fillers, dyes, perfumes, brighteners, colorants, or any combination thereof. Generally, the textile sanitizing composition includes a sanitizing effective amount of the partially halogenated hydantoin.

Yet another embodiment of the present invention is a method of cleaning and sanitizing a textile by applying a detergent and a sanitizing effective amount of partially halogenated hydantoin to the textile. The partially halogenated hydantoin may be added separately from the detergent to the textile. According to one preferred embodiment, a wash cycle additive comprising at least one partially halogenated hydantoin is applied to the textile separate from the detergent. The wash cycle additive may further comprise other ingredients, such as filler, dyes, perfumes, brighteners, colorants, or a combination thereof.

Yet another embodiment is a sanitizing and detergent composition which includes a detergent, a sanitizing effective amount of at least one partially halogenated hydantoin, and optionally, one or more additives. Generally, the detergent composition includes a cleaning effective amount of detergent.

### DETAILED DESCRIPTION OF THE INVENTION

The inventors have discovered that partially halogenated hydantoins are highly effective at sanitizing textiles, and fade and degrade textiles less than other sanitizing agents, such as trichloroisocyanuric acid (TCCA) and sodium dichloroisocyanurate (DCCA).

The present invention is directed to a method of sanitizing a textile (such as a colored textile) by applying a sanitizing effective amount of partially halogenated hydantoin to the textile. Typically, the partially halogenated hydantoin is applied to the textile in a solvent, such as water. This method may be used to sanitize natural and synthetic fabrics, as well as blends of fabrics. Examples of such textiles include, but are not limited to, cotton, polyester, and cotton/polyester blends.

The term “partially halogenated hydantoin” is defined herein as a mixture of halogenated hydantions and, optionally, non-halogenated hydantoins, having a degree of halogenation greater than 0 but less than 2. The mixture may be a liquid or solid. The degree of halogenation is the average number of halogen atoms associated with each hydantoin molecule in the solution. For example, a solution having an average of 1.5 chlorine atoms associated with each hydantoin molecule, i.e., Cl₁₅ hydantoin, has a degree of halogenation of 1.5. The term “solution” as used herein includes, but is not limited to, solids, liquids, and gases.

The partially halogenated hydantoin may be an X₍₂₋ₙ₎ dialkyl hydantoin, where X is a halogen, such as chlorine, bromine, or a combination thereof, and 0<n<2. Preferably, n ranges from about 0.5 to about 1.5. The alkyl moieties of the partially halogenated hydantoin may be the same or different. A suitable hydantoin has the formula

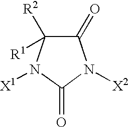

where X¹ and X² are independently hydrogen or halogen and R¹ and R² are independently linear or branched C₁-C₁₀alkyl. R¹ and R² may be the same or different.

The partially halogenated hydantoin is preferably X₍₂₋ₙ₎ di-(C₁-C₁₀) alkyl hydantoin, more preferably X₍₂₋ₙ₎ di-(C₁-C₄) alkyl hydantoin, and most preferably X₍₂₋ₙ₎ dimethyl hydantoin. Preferred partially halogenated hydantoins include, but are not limited to, monochloro-5,5-dimethyl hydantoin (MCDMH), monobromo-5,5-dimethyl hydantoin (MBDMH), monochloro-5-methyl-5-ethyl hydantoin, monobromo-5-methyl-5-ethyl hydantoin, and any combination of any of the foregoing. A most preferred hydantoin is monochlorodimethyl hydantoin.

The partially halogenated hydantoin may be a solid. The term solid includes, but is not limited to, powder, granules, tablets, briquettes and slurries. An example of a solid partially halogenated hydantoin includes, but is not limited to, MCDMH.

A detergent and other additives, such as fillers, dyes, perfumes, brighteners, colorants and any combination thereof, may be applied to the textile prior to, after, or simultaneously with the partially halogenated hydantoin. For example, a composition (such as a wash cycle additive) containing the partially halogenated hydantoin and, optionally, additives may be applied to the textile. According to one embodiment, the composition is in the form of a tablet, powder or liquid.

The term “sanitizing” as used herein refers to killing, inhibiting the growth of, and/or removing microorganisms (such as bacteria and fungi) from a textile.

The term “sanitizing effective amount” as used herein refers to an amount of an agent effective to control the number of microorganisms (such as bacteria (e.g., Klebsiella pneumonia and Staphylococcus aureus) and fungi) in and/or on a textile, i.e., to kill or inhibit the growth of the microorganisms. Desirably, the amount of agent is effective to reduce the number of microorganisms in and on the textile by 50, 60, 70, 80, 90, 95, 96, 97, 98, 99, 99.5, or 99.9%. The term “color safe effective amount” is herein defined as an amount of partially halogenated hydantoin which does not cause a substantial change in the color of the textile. A change in the color of the textile is quantitatively calculated as ΔE, determined by ASTM D-5548-95 after five cycles. The term “textile safe effective amount” is herein defined as an amount of partially halogenated hydantoin which does not substantially damage the textile.

The composition generally contains an antimicrobial or sanitizing effective amount of partially halogenated hydantoin. Preferably, the composition contains a sanitizing, color safe, and/or textile safe effective amount of partially halogenated hydantoin. Such a composition may be prepared by mixing the appropriate ingredients.

According to a preferred embodiment, a detergent and/or other additives are mixed with the partially halogenated hydantoin prior to applying it to the textiles. For example, the partially halogenated hydantoin may be mixed with a detergent (e.g., a cleaning effective amount of detergent) and optionally other additives, to form a sanitizing and detergent composition suitable for applying to the textile. Suitable additives include, but are not limited to, surfactants (anionic, nonionic, cationic, zwitterionic, amphoteric), builders (zeolites, phosphates, polycarboxylates, carbonates, silicates), enzymes (protease, amylase, lipase, cellulase), dyes, perfumes, colorants, optical brighteners, processing aids, and combination thereof. Preferably, the sanitizing and detergent composition contains a santizing, color safe, and/or textile safe concentration of the partially halogenated hydantoin. The concentration of the partially halogenated hydantoin in the sanitizing and detergent composition generally ranges from about 0.2 to about 2% (w/w).

Generally, an antimicrobial effective amount of the partially halogenated hydantoin is applied to the textile. An antimicrobial effective amount is herein defined as an amount of partially halogenated hydantoin which inhibits the growth of or kills bacteria, fungi or viruses on the textiles and in the wash water. More preferably, a sanitizing, color safe, and textile safe effective amount of partially halogenated hydantoin is applied.

The partially halogenated hydantoin may be applied to the textiles by any method known in the art. Such methods include, but are not limited to, as an ingredient in powder or tablet laundry detergents or as an ingredient in a wash cycle additive formulation which is added to the water in a washing machine or a receptacle for hand washing the textiles either prior to or after adding a detergent. Preferably, the mixture containing water, the partially halogenated hydantoin, and the textile are mixed to uniformly distribute the partially halogenated hydantoin. For example, the partially halogenated hydantoin may be applied to a textile in a washing machine.

The concentration of the partially halogenated hydantoin maintained in the mixture is generally a sanitizing, antimicrobial, antifungal, and/or antibacterial effective amount. Preferably, a sanitizing, color safe, and textile safe effective amount of partially halogenated hydantoin is maintained in the mixture. The concentration of the partially halogenated hydantoin maintained in the mixture broadly ranges from about 1 to about 200 ppm, preferably ranges from about 20 to about 60 ppm, and more preferably ranges from about 30 to about 50 ppm (expressed as Cl₂). When referred to in this specification, concentrations of Cl₂ are expressed as total chlorine.

The partially halogenated hydantoin is also effective in water having a hardness of greater than about 100, 150, 200, 300, and 400 ppm. According to a preferred embodiment, the water has a hardness from about 100 or 150 ppm to about 200, 300, or 400 ppm.

Another embodiment is a method of sanitizing a textile while minimizing color change and damage to the textile by applying a sanitizing, color safe, and textile safe effective amount of partially halogenated hydantoin and water to the textile.

Yet another embodiment is a method of simultaneously laundering and sanitizing a textile by applying water and the aforementioned sanitizing and detergent composition to the textile. Generally, a cleaning effective amount of detergent is maintained in the laundry water. The concentration of the detergent in the laundry water broadly ranges from about 0.5 grams/liter to about 10 grams/liter, and preferably ranges from about 1 gram/liter to about 3 grams/liter.

The following examples are intended to describe the present invention without limitation.

### EXAMPLE 1

Bioefficacy studies were performed using cotton fabric samples to compare monochloro dimethyl hydantoin (MCDMH) to trichloroisocyanuric acid (TCCA) and sodium dichloroisocyanurate (DCCA), two chlorine bleaches. Mixtures of Tide® powder, available from Procter and Gamble of Cincinnati, Ohio, and the sanitizers specified in Table 1 were prepared and thereafter dissolved in water. The sanitizers were completely dissolved in the water before testing. The mixtures were tested according to the known Petrocci & Clarke method (A. Petrocci and P. Clarke, Proposed Test Method for Antimicrobial Laundry Additives, Journal of the Association of Official Analytical Chemists, 52(4), 836-842 (1969)) against K. pneumoniae. The percent reduction of K. pneumonia on the fabric and on the wash water was determined. The results are shown in Table 1.

TABLE 1

| | Concentration | Percent | Percent |
|---|---|---|---|
| | of Sanitizer | Reduction of | Reduction of |
| | (expressed as | K. pneumonia | K. pneumonia |
| Sanitizer | Cl₂)(ppm) | on Fabric | in Wash Water |
| None | 0 | 88.82 | 61.33 |
| DCCA | 30 | 96.36 | 87.50 |
| TCCA | 30 | 97.09 | 96.38 |
| MCDMH | 30 | 99.60 | 99.76 |

MCDMH was more effective in reducing K. pneumonia on fabric and in wash water than DCCA, TCCA, or detergent alone.

### EXAMPLE 2

The color change of a Fruit of the Loom® black cotton T-shirt (ΔE) due to the application of a mixture of Tide® liquid and the sanitizers listed in Table 2 below was determined according to ASTM D-5548-95, which is hereby incorporated by reference. The ΔE was determined after five cycles, one cycle consisting of a washing, rinsing and drying the black cotton T-shirt. The results are shown in Table 2.

TABLE 2

| | Concentration of Sanitizer | |
|---|---|---|
| Sanitizer | (expressed as Cl₂) (ppm) | ΔE after 5 cycles |
| None | 0 | 0.72 |
| MCDMH | 30 | 1.43 |
| DCCA | 30 | 1.51 |
| NaOCl | 30 | 2.25 |

Table 2 shows that Tide® liquid with MCDMH caused the least color damage to the T-shirts.

### EXAMPLE 3

The color safety test of monochloro dimethyl hydantoin (MCDMH), dichloro dimethyl hydantoin (DCDMH), sodium dichloroisocyanurate (DCCA), trichloroisocyanuric acid (TCCA), and hypochlorite bleach (NaOCl) was determined according to the procedure described in Example 2, except no detergent was used. Each sanitizer was applied to a Hanes® blue cotton T-shirt at a concentration of 25 ppm (expressed as Cl₂). After three cycles, the Hanes® blue cotton T-shirts showed fading that increased in the following order:

MCDMH<DCDMH<DCCA<TCCA<NaOCl

### EXAMPLE 4

The following test was performed to determine the degree of fabric damage due to various bleaches. About 0.1 grams of bleach powder was folded up inside a wool, silk, or cotton swatch which was bundled up with a rubber band. Similar swatches containing monochloro dimethyl hydantoin (MCDMH), dichloro dimethyl hydantoin (DCDMH), sodium dichloroisocyanurate (DCCA), and trichloroisocyanuric acid (TCCA) were bundled up with a rubber band. All samples were compared on an equal chlorine basis, i.e., the amount of powder needed to produce 50 ppm chlorine in a 64 liter wash. Swatches were left in a beaker of tap water at 45° C. with half the bleach powder for 30 minutes. The other half of the bleach powder was added, and the swatch was bundled again. The swatch was then placed in a 75° C. oven to dry for an hour. This cycle was repeated until fabric damage was observed. TCCA created holes in a wool swatch after 4 cycles, a silk swatch after 7 cycles, and a cotton swatch after 11 cycles. DCCA caused a hole in a wool swatch after 7 cycles and in a silk swatch after 12 cycles. After 23 cycles with a wool swatch and with a silk swatch and 28 cycles with a cotton swatch, MCDMH had not yet caused any pin-holes.

### EXAMPLE 5

A simulated “in-use” laundry sanitation test, as described in Petrocci and Clarke, supra, was conducted to evaluate the activity of the samples listed in Table 3 below.

The test was performed as follows. Fabric swatches were inoculated and dried with ˜20,000,000 cfu test organism. (Staphylococcus aureus ATCC 6538, Klebsiella pneumoniae ATCC 4352). The swatches were exposed to a sample dilution for 10 minutes followed by neutralization and enumeration of survivors. The percent reduction of bacteria was calculated for the fabric swatches and wash water.

The sample dilutions were prepared as follows. Tide® powder and MCDMH were dissolved separately in water and mixed together. Then the mixture was adjusted to 150 ppm hard water. The Tide® powder mixture contained about 1.8 g of Tide® powder per liter of mixture.

TABLE 3

| | Concentration of | | | | |
|---|---|---|---|---|---|
| | Sanitizer | % Reduction in 10 Minutes | | | |
| Description of | (expressed as | S. aureus | | K. pneumonia | |
| Sample | Cl₂) (ppm) | Fabric | Water | Fabric | Water |
| Tide ® powder | 5 | 100 | 100 | 63.16 | 26.32 |
| with MCDMH | 10 | 99.99 | 100 | 47.37 | 0 |
| | 20 | 99.92 | 100 | 68.42 | 47.37 |

### EXAMPLE 6

The procedure in Example 5 was repeated with Klebsiella pneumonia ATCC 4352 only. The samples and the results are shown in Table 4 below. The Tide® liquid sample was prepared by the same procedure as the Tide® powder sample described in Example 5. The Tide® liquid mixture contained about 1.8 g of Tide® liquid per liter of mixture.

TABLE 4

| | Concentration of | | % Reduction in | |
|---|---|---|---|---|
| | Sanitizer | | 10 Minutes - | |
| | (expressed as Cl₂) | | Kiebsiella | |
| Description of Sample | (ppm) | pH* | Fabric | Water |
| MCDMH | 5 | 7.0 | 99.99 | 100 |
| | 10 | 7.0 | 100 | 100 |
| | 20 | 7.0 | 100 | 100 |
| Tide ® Liquid | 10 | 7.0 | 100 | 100 |
| with MCDMH | 20 | 7.0 | 100 | 100 |
| | 30 | 7.0 | 100 | 100 |
| Tide ® Powder with | 30 | 9.5 | 99.83 | 99.96 |
| MCDMH | 40 | 9.5 | 99.99 | 99.99 |

* - Indicator strips used for pH measurements.

All patents, publications, applications, and test methods mentioned above are hereby incorporated by reference. Many variations of the present matter will suggest themselves to those skilled in the art in light of the above detailed description. All such obvious variations are within the patented scope of the appended claims.

What is claimed is:

1. A method of sanitizing a textile comprising applying a sanitizing effective amount of a partially halogenated hydantoin to the textile in water.

2. The method of claim 1, wherein the partially halogenated hydantoin is X₍₂₋ₙ₎ dialkylhydantoin, where X is chlorine, bromine, or a combination thereof and 0<n<2.

3. The method of claim 2, wherein the partially halogenated hydantoin is X₍₂₋ₙ₎ di-(C₁-C₁₀) alkyl hydantoin.

4. The method of claim 3, wherein the partially halogenated hydantoin is X₍₂₋ₙ₎ di-(C₁-C₄) alkyl hydantoin.

5. The method of claim 4, wherein the partially halogenated hydantoin is X₍₂₋ₙ₎ 5,5-dimethyl hydantoin.

6. The method of claim 4, wherein the partially halogenated hydantoin is X₍₂₋ₙ₎ 5-methyl-5-ethyl hydantoin.

7. The method of claim 2, wherein n ranges from about 0.5 to about 1.5.

8. The method of claim 1, wherein the partially halogenated hydantoin is monochlorodimethyl hydantoin, monobromodimethyl hydantoin, or any combination of any of the foregoing.

9. The method of claim 1, wherein the partially halogenated hydantoin is monochlorodimethyl hydantoin.

10. The method of claim 1, wherein the partially halogenated hydantoin is a solid.

11. The method of claim 1, wherein the partially halogenated hydantoin is in the form of granules or a tablet.

12. The method of claim 1, further comprising applying a detergent to the textile.

13. The method of claim 12, wherein the detergent is mixed with the partially halogenated hydantoin prior to applying the partially halogenated hydantoin and the detergent to the textile.

14. The method of claim 1, further comprising applying a filler, a dye, a perfume, a brightener and a colorant, or any combination thereof to the textile.

15. The method of claim 1, wherein an antimicrobial effective amount of partially halogenated hydantoin is applied to the textile.

16. The method of claim 1, wherein the concentration of partially halogenated hydantoin applied to the textile ranges from about 1 to about 200 ppm (expressed as Cl₂).

17. The method of claim 1, wherein the concentration of partially halogenated hydantoin applied to the textile ranges from about 20 to about 60 ppm (expressed as Cl₂).

18. The method of claim 1, wherein the concentration of partially halogenated hydantoin applied to the textile ranges from about 30 to about 50 ppm (expressed as Cl₂).

19. A method of sanitizing a textile while minimizing damage to the textile, the method comprising applying water and a textile safe effective amount of partially halogenated hydantoin to the textile.

20. A method of sanitizing a textile while minimizing color change and damage to the textile, the method comprising applying water and a sanitizing, color safe, and textile safe effective amount of partially halogenated hydantoin to the textile.

21. A method of simultaneously laundering and sanitizing a textile comprising applying a composition comprising a detergent and a partially halogenated hydantoin to the textile.

22. In a process for cleaning textiles, the improvement comprising performing the process in the presence of a sanitizing effective amount of partially halogenated hydantoin.

23. A sanitizing and detergent composition comprising
(a) a detergent; and
(b) a sanitizing effective amount of at least one partially halogenated hydantoin.

24. The sanitizing and detergent composition of claim 20, further comprising a filler, a dye, a perfume, a colorant, or any combination thereof.
